(19) United States
(12) Patent Application Publication
(10) Pub. No.: US 2024/0069763 A1
(43) Pub. Date: Feb. 29, 2024

(54) MEMORY CONTROLLER AND MEMORY ACCESS METHOD

(71) Applicant: Sony Semiconductor Solutions Corporation, Kanagawa (JP)

(72) Inventor: Yasufumi Sugimori, Kanagawa (JP)

(21) Appl. No.: 18/261,365

(22) PCT Filed: Jan. 6, 2022
(86) PCT No.: PCT/JP2022/000171

§ 371 Date: Jul. 13, 2023

(30) Foreign Application Priority Data
Feb. 25, 2021 (JP) 2021-028220

(51) Int. Cl. G06F 3/06

(52) U.S. Cl. CPC G06F 3/0625; G06F 3/0656; G06F 3/0659; G06F 3/0679

(57) ABSTRACT

The present disclosure relates to a memory controller and a memory access method that make it possible to suppress occurrence of useless access.

A readout controlling section starts, in response to a burst access request for a memory, reading out of data from the memory without depending on completion of the burst access request. A buffer stores multiple pieces of data read out from the memory, and an output controlling section outputs the multiple pieces of data stored in the buffer, according to a protocol of an outputting destination. The technology according to the present disclosure can be applied, for example, to LSI that is built in a TWS for which Bluetooth is used.

### TECHNICAL FIELD

The present disclosure relates to a memory controller and a memory access method, and particularly to a memory controller and a memory access method that suppress occurrence of useless access.

### BACKGROUND ART

In a computer, in order to reduce the load caused by access to a storage device such as a flash memory on a processor such as a CPU (Central Processing Unit), a cache memory is provided between the processor and the storage device. The cache memory manages multiple successive words as one line and, at the time of a cache miss, reads in the multiple words all together. At this time, burst transfer is used for data transfer from the storage device.

Further, hierarchization of a memory has progressed, and a pre-fetch buffer is sometimes provided between the cache memory and the storage device.

PTL 1 discloses a pre-fetch circuit that converts, when wraparound memory access requests having sizes different from each other are generated, a starting address in such a manner as to decrease stall cycles of a processor.

### CITATION LIST

### Patent Literature

[PTL 1]
Japanese Patent Laid-open No. 2012-146139

### SUMMARY

### Technical Problem

Incidentally, useless access to a storage device increases the power consumption.

The present disclosure has been made in view of such a situation as described above and suppresses occurrence of useless access.

### Solution to Problem

The memory controller of the present disclosure is a memory controller including a readout controlling section that starts, in response to a burst access request for a memory, reading out of data from the memory without depending on completion of the burst access request, a buffer that stores multiples pieces of the data read out, and an output controlling section that outputs the multiple pieces of the data stored in the buffer according to a protocol of an outputting destination.

The memory access method of the present disclosure is a memory access method by a memory controller, including starting, in response to a burst access request for a memory, reading out of data from the memory without depending on completion of the burst access request, storing multiple pieces of the data read out into a buffer, and outputting the multiples pieces of the data stored in the buffer, according to a protocol of an outputting destination.

In the present disclosure, in response to a burst access request for the memory, reading out of data from the memory is started without depending on completion of the burst access request. Then, multiple pieces of the data read out are stored into the buffer, and the multiple pieces of the data stored in the buffer are outputted according to a protocol of the outputting destination.

### BRIEF DESCRIPTION OF DRAWINGS

FIG. 1 is a view illustrating a TWS for which Bluetooth is used.

FIG. 2 is a block diagram depicting an example of a configuration of LSI.

FIG. 3 is a block diagram depicting an example of a functional configuration of a memory controller.

FIG. 4 is a flow chart illustrating a flow of a memory access process.

FIG. 5 is a diagram depicting an example of reading out of data in response to a normal bus request.

FIG. 6 is a diagram depicting an example of reading out of data in response to a bus request made at the time of a cache miss.

FIG. 7 is a flow chart illustrating a flow of the memory access process in response to a burst access request.

### DESCRIPTION OF EMBODIMENT

In the following, a mode for carrying out the present disclosure (hereinafter referred to as an embodiment) is described. It is to be noted that the description is given in the following order.
1. TWS for which Bluetooth is used and its challenge
2. Configuration of LSI and memory controller
3. Flow of memory access process
4. Modification

### 1. TWS for which Bluetooth is Used and its Challenge

In recent years, earphones for a smartphone have rapidly come into widespread use as a TWS (True Wireless Stereo) for which Bluetooth (registered trademark) is used.

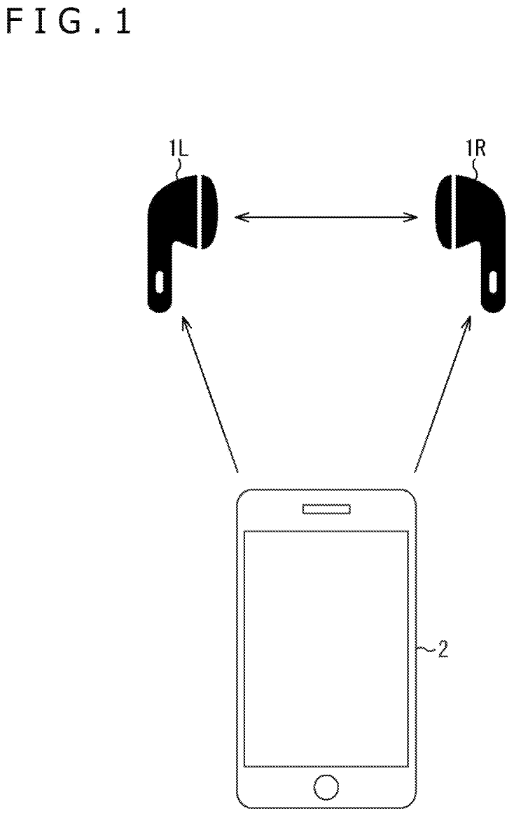

FIG. 1 is a view illustrating the TWS for which Bluetooth is used. In FIG. 1, earphones 1L and 1R to be mounted on the left and right ears and a smartphone 2 are depicted.

The earphones 1L and 1R perform, in a state in which they are paired with each other, wireless communication with the smartphone 2 with use of BLE (Bluetooth Low Energy) to reproduce music.

In particular, for example, the earphone 1R receives music data from the smartphone 2 and separates the music data into sound for the left and the right. The right sound and the left sound that are each separated sound are reproduced in synchronism with each other by the earphone 1R and the earphone 1L, respectively. It is to be noted that the music data from the smartphone 2 may otherwise be received by the earphone 1L.

For such earphones 1L and 1R as described above, it is demanded that the power consumption be low because they have a small housing and also have a small battery volume.

Here, as an example in which a UI command originating from an operation on the earphone 1R mounted on the right ear is reflected on both of the earphones 1L and 1R, examined is a case in which reproduction of music from each of the earphones 1L and 1R is started in response to an operation on the earphone 1R.

In this case, not satisfying a certain response speed gives such anxiety to the user that the UI is not reacting appropriately, leading to difficulty in use. Accordingly, even in such a low power state that the earphones 1L and 1R operate with a low frequency clock as in a standby state, in a case where such a UI command as described hereinabove is generated, it is necessary to execute the process in a short period of time.

On the other hand, although it is possible to improve the processing performance by increasing the clock frequency, this increases the power consumption.

Further, for example, in a case where a processor develops execution codes stored in a flash memory into an SRAM (Static Random Access Memory) or the like at the time of staring, depending on the code size, it is necessary to increase the capacity or the area of the SRAM, possibly affecting reduction in size of the housing.

As such, in order to maintain the processing performance while reduction in power consumption and size is implemented, constructed is a system which includes a flash memory, into which execution codes are to be stored, externally and operates by use of a cache memory. In this case, useless access to the external flash memory increases the power consumption.

In the following, a memory controller and a memory access method that suppress occurrence of useless access are described.

### 2. Configuration of LSI and Memory Controller

### (Example of Configuration of LSI)

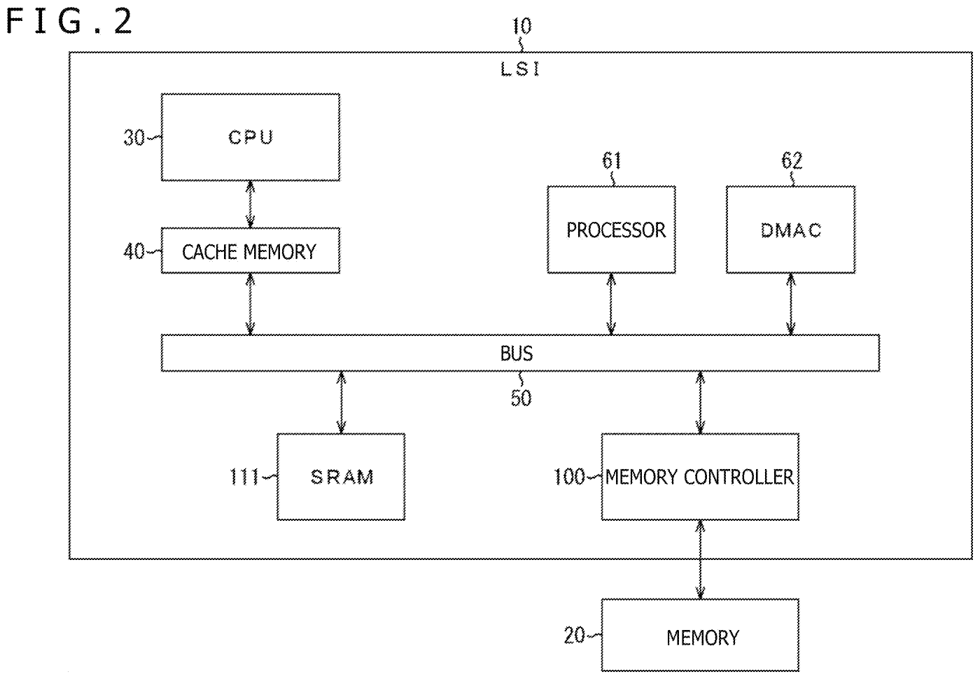

FIG. 2 is a block diagram depicting an example of a configuration of LSI (Large Scale Integration) that includes a memory controller to which the technology according to the present disclosure is applied.

LSI 10 depicted in FIG. 2 is built, for example, in the earphones 1L and 1R illustrated in FIG. 1 and executes processes relating to reproduction of music and so forth. The LSI 10 is electrically connected to a memory 20 that is an external code memory that is provided externally. The memory 20 is a nonvolatile memory and includes, for example, a flash memory. It is to be noted that the LSI 10 can be configured to be built not only in the earphones 1L and 1R illustrated in FIG. 1 but also in any electronic apparatus for which reduction in power consumption and size is demanded and to execute predetermined processes.

The LSI 10 includes a CPU 30, a cache memory 40, a bus 50, a processor 61, a DMAC (Direct Memory Access Controller) 62, a memory controller 100, and an SRAM 111.

The CPU 30 executes a process in accordance with a command of a program. Such commands of the program are retained in a command retention area of the memory 20. Meanwhile, pieces of data necessary for processes are retained in a data retention area of the memory 20.

The cache memory 40 retains a copy of some of contents of the command retention area and the data retention area of the memory 20.

The bus 50 is configured as a memory bus that connects the cache memory 40, the processor 61, the DMAC 62, the memory controller 100, and the SRAM 111 to one another.

The processor 61 executes a process different from that executed by the CPU 30. The DMAC 62 controls transfer of data between the CPU 30 and the memory 20 in accordance with a command of the CPU 30.

The memory controller 100 controls access to the memory 20. The memory 20 is shared by the CPU 30 and the processor 61 via the memory controller 100.

The SRAM 111 is a nonvolatile RAM and is small in latency and also in capacity in comparison with the memory 20. In particular, while the memory 20 allows data access thereto in a unit of a large size, the SRAM 111 allows high speed random access thereto in a smaller unit.

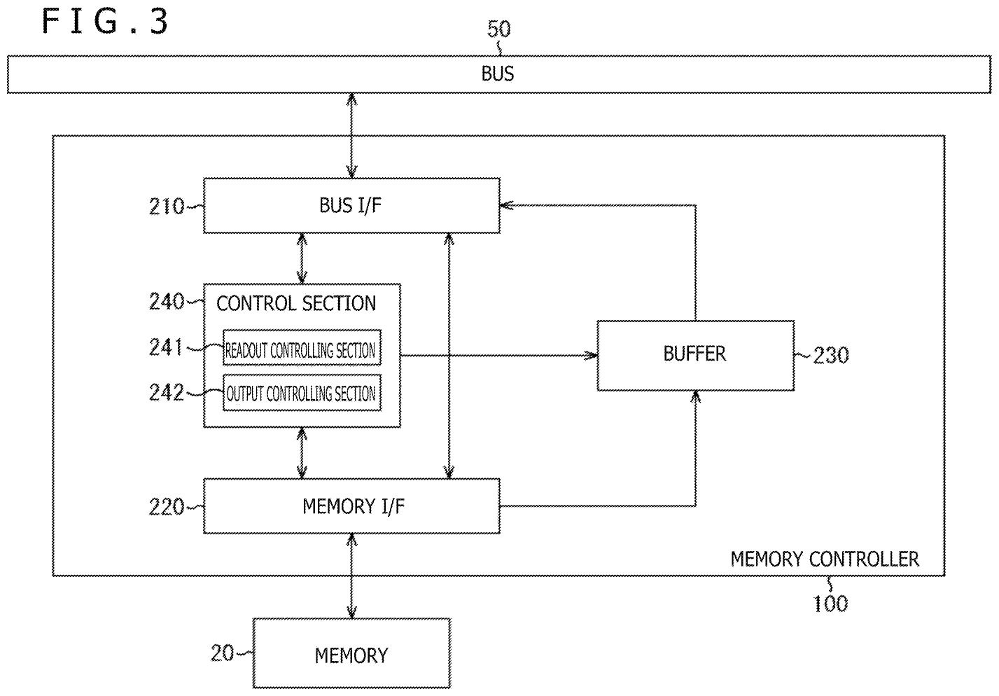

(Example of Configuration of Memory Controller) FIG. 3 is a block diagram depicting an example of a functional configuration of the memory controller 100.

The memory controller 100 includes a bus I/F (Interface) 210, a memory I/F 220, a buffer 230, and a control section 240.

The bus I/F 210 mutually exchanges data and commands with the CPU 30 through the bus 50.

The memory I/F 220 mutually exchanges data and commands with the memory 20.

The buffer 230 temporarily stores data read out from the memory 20 by the memory I/F 220.

The control section 240 includes a microprocessor and so forth and controls the overall memory controller 100. The control section 240 executes a predetermined program to implement a readout controlling section 241 and an output controlling section 242.

The readout controlling section 241 controls the memory I/F 220 to control reading out of data from the memory 20, in response to a data access request for the memory 20. The data read out is outputted to the bus 50 via the bus I/F 210 and is temporarily stored into the buffer 230.

The output controlling section 242 controls the bus I/F 210 to output data read out from the memory 20 by the memory I/F 220 or data temporarily stored in the buffer 230 to the bus 50. The output controlling section 242 outputs the data according to a bus protocol of the bus 50 that is an outputting destination.

### 3. Flow of Memory Access Process

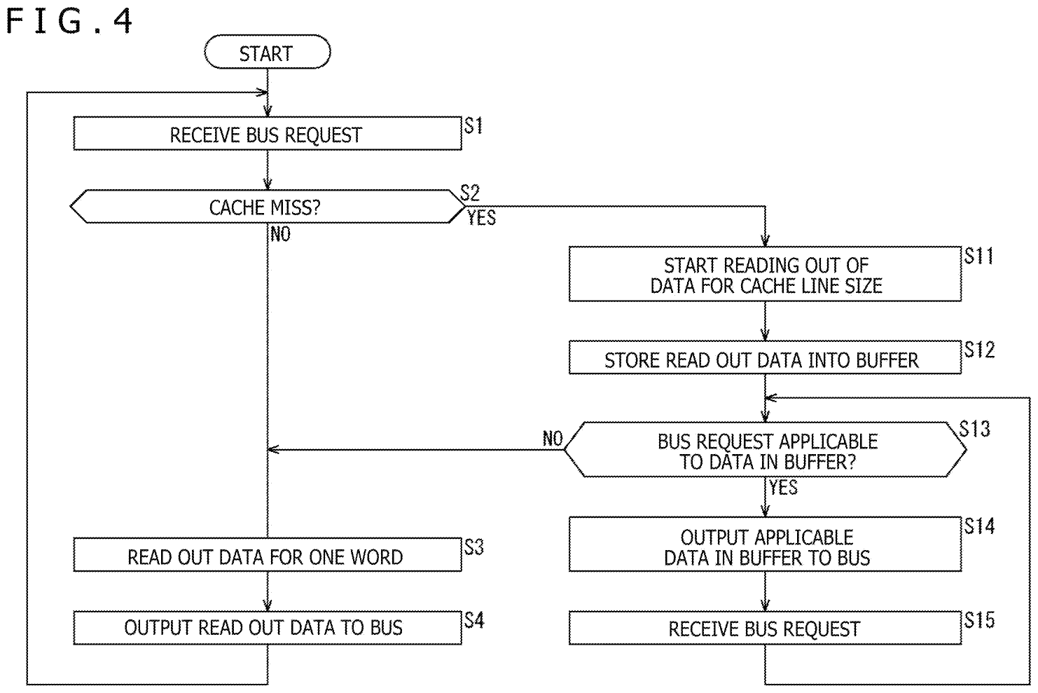

Now, a flow of a memory access process by the memory controller 100 is described with reference to a flow chart of FIG. 4.

In step S1, the bus I/F 210 receives a bus request from the CPU 30 through the bus 50.

In step S2, the control section 240 determines whether or not the bus request from the CPU 30 is an access request (burst access request) according to a cache miss in the cache memory 40. Whether or not the bus request is an access request according to a cache miss is determined according to whether or not a notification that a flag indicative of occurrence of a cache miss is added is given from a side band signal of the bus 50.

In a case where it is determined that the bus request is not an access request according to a cache miss, the processing advances to step S3.

In step S3, the readout controlling section 241 controls the memory I/F 220 to access the memory 20 in response to the access request and thereby read out data for one word that is an access unit of the memory 20.

In step S4, the output controlling section 242 controls the bus I/F 210 to output the data for one word read out from the memory I/F 220 to the bus 50. After step S4, the processing returns to step S1, in which a next bus request is received.

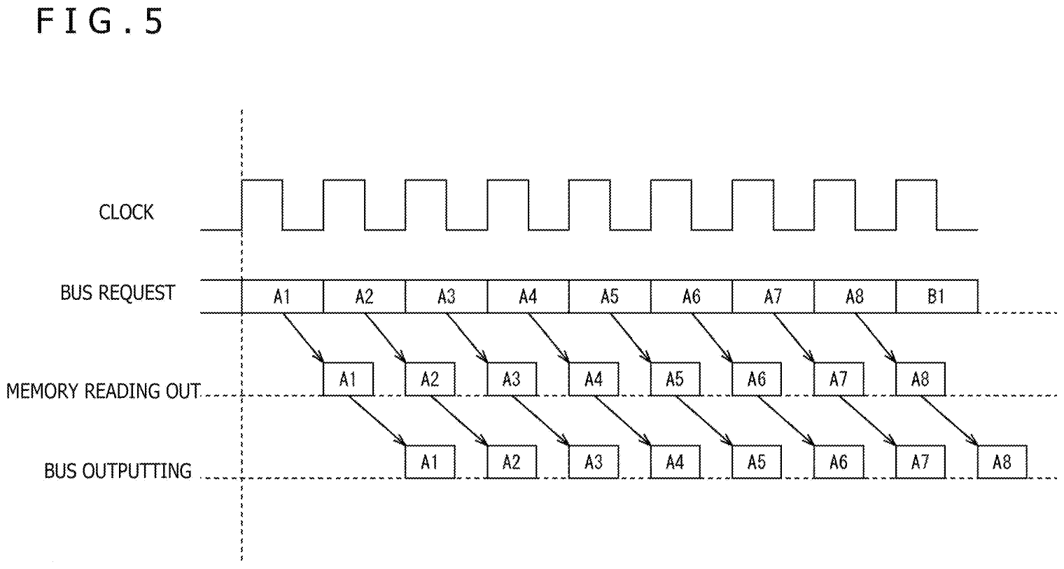

FIG. 5 is a diagram depicting an example of reading out of data in response to an ordinary bus request.

In the example of FIG. 5, an access request for data for eight words is received as the bus request. The bus request is generated at a timing coincident with a clock. In FIG. 5, reference signs “A1” to “A8” represent addresses of the memory 20.

As depicted in FIG. 5, pieces of data corresponding to the addresses “A1” to “A8” are read out one word by one word from the memory 20 in response to the bus request. Such memory access may be performed, for example, according to the AHB protocol of Arm Limited or may be performed according to some other bus protocol such as the AXI protocol or the OCP protocol.

Described with reference to the flow chart of FIG. 4 again, in a case where it is determined in step S2 that the bus request from the CPU 30 is an access request according to a cache miss, the processing advances to step S11.

Since the bus request at the time of a cache miss is a reading out request for data for a cache line size, the readout controlling section 241 controls the memory I/F 220 in step S11 to start reading out of data for the cache line size. The cache line size is, for example, 32 Bytes (8 words).

Here, without depending on completion of the bus request, pieces of data for the cache line size are read out sequentially in advance.

In step S12, the readout controlling section 241 stores the data read out by the memory I/F 220 into the buffer 230.

In step S13, the control section 240 determines whether or not the bus request from the CPU 30 received according to the bus clock is a request applicable to the data stored in the buffer 230.

In a case where it is determined that the bus request from the CPU 30 is a request applicable to the data stored in the buffer 230, the processing advances to step S14.

In step S14, the output controlling section 242 controls the bus I/F 210 to output, to the bus 50, data for one word in the buffer 230 applicable to the bus request from the CPU 30.

Thereafter, in step S15, the bus I/F 210 receives a next bus request from the CPU 30 through the bus 50. After the next bus request is received, the processing returns to step S13, in which it is determined whether or not the received bus request is a request applicable to the data stored in the buffer 230.

The processes in steps S13 to S15 are repeated until the pieces of data for the cache line size stored in the buffer 230 are all outputted to the bus 50.

When an ordinary bus request is received in step S15 after that, it is determined in step S13 that the bus request is not a request applicable to the data stored in the buffer 230, and the processing returns to step S3.

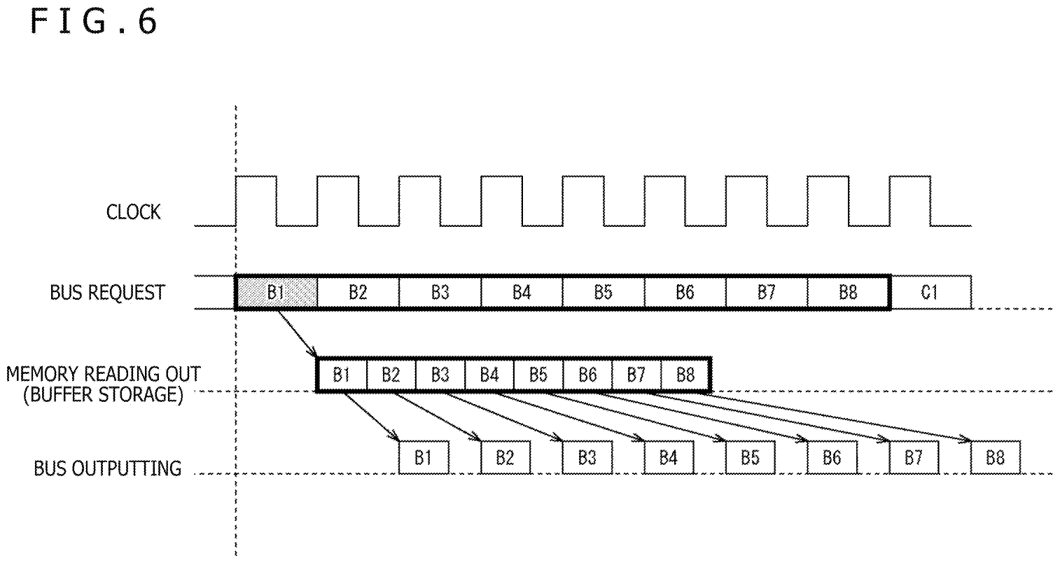

FIG. 6 is a diagram depicting an example of reading out of data according to a bus request made at the time of a cache miss.

In the example of FIG. 6, a burst access request for data for the cache line size (for eight words) is received as the bus request. In FIG. 6, reference signs “B1” to “B8” represent addresses of the memory 20.

As depicted in FIG. 6, in reference to the address “B1” for the first word in the bus request, pieces of data corresponding to the addresses “B1” to “B8” for the cache line size are read out from the memory 20 in advance and stored into the buffer 230. The pieces of data corresponding to the addresses “B1” to “B8” stored in the buffer 230 are outputted one word by one word at a timing conforming to the bus request according to the bus protocol.

According to the processes described above, at the time of a cache miss, reading out of data for the cache line size is started in advance, and the pieces of read out data are sequentially stored into the buffer 230. Consequently, it is possible to minimize the miss penalty (time loss) at the time of a cache miss and thereby suppress occurrence of useless access. As a result, increase of the power consumption can be suppressed without the clock frequency being increased, and for example, it is possible to implement reduction in power consumption and size and maintain the processing performance in LSI that is incorporated in an electronic apparatus such as a TWS for which Bluetooth is used.

### 4. Modification

In the following, a modification of the embodiment according to the present disclosure described above is described.

### (Memory Access Process in Response to Burst Access Request)

The memory access process of the memory controller 100 described above can be applied not only to a bus request made at the time of a cache miss but also to a burst access request for successively accessing multiple pieces of data in reference to a single address.

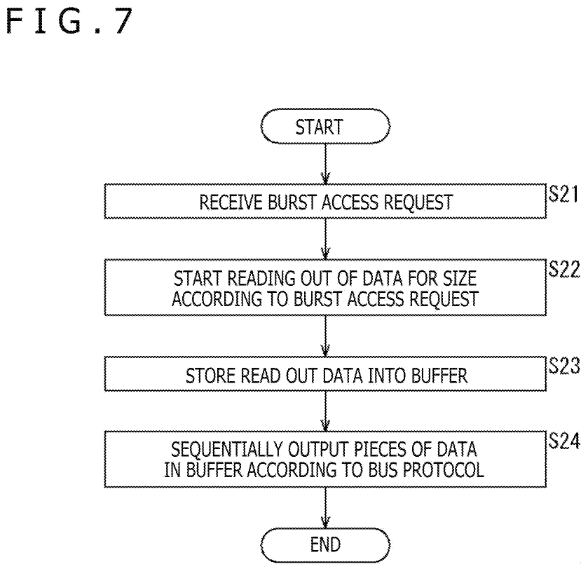

FIG. 7 is a flow chart illustrating a flow of the memory access process in response to a burst access request.

In step S21, the bus I/F 210 receives a burst access request from the CPU 30 through the bus 50. The burst access request here is, for example, a request according to development of firmware to an SRAM or the like at the time of system starting or an access request for audio data.

In step S22, the readout controlling section 241 controls the memory I/F 220 to start reading out of data for a size according to the burst access request. The pieces of data for the size according to the burst access request are pieces of data to which an access order is determined in advance such as firmware that is developed into an SRAM or the like or audio data.

In step S23, the readout controlling section 241 stores the data read out by the memory I/F 220 into the buffer 230.

In step S24, the output controlling section 242 controls the bus I/F 210 to output the pieces of data in the buffer 230 sequentially to the bus 50 according to the bus protocol.

According to the processes described above, it is possible to suppress occurrence of useless access with respect to a burst access request for data to which the access order is determined in advance and thus suppress increase of the power consumption.

### (Application to Wraparound Memory Access)

In the embodiment described above, reading out of data is started in reference to an address for the first word in the bus request. This is not restrictive, and a memory controller that performs wraparound memory access may start reading out of data from required addresses in reference to the address for the first word in the bus request and wraparound access information.

### (Different Example of Memory)

Although the memory 20 in the embodiment described above includes a flash memory, it may otherwise include a nonvolatile memory of a different type such as an MRAM (Magnetoresistive Random Access Memory), a ReRAM (Resistive RAM), a FeRAM (Ferroelectric RAM), or a phase change memory.

Further, although it is described that the memory 20 is an external code memory, it may otherwise be an on-chip memory provided on the LSI 10.

The memory controller to which the technology according to the present disclosure is applied is provided not only in LSI built in a TWS for which Bluetooth is used but also in any LSI.

In other words, the embodiment of the technology according to the present disclosure is not restricted to the embodiment described above and can be altered in various manners without departing from the subject matter of the technology according to the present disclosure.

Further, the advantageous effects described in the present specification are exemplary to the last and are not restrictive, and other advantageous effects may be available.

Furthermore, the technology according to the present disclosure can take the following configurations.

(1)

A memory controller including:
a readout controlling section that starts, in response to a burst access request for a memory, reading out of data from the memory without depending on completion of the burst access request;
a buffer that stores multiple pieces of the data read out; and
an output controlling section that outputs the multiple pieces of the data stored in the buffer, according to a protocol of an outputting destination.
   (2)

The memory controller according to (1), in which
the burst access request is a bus request according to a cache miss in a cache memory.
   (3)

The memory controller according to (2), in which
the readout controlling section starts the reading out of the data for a cache line size in response to the bus request.
   (4)

The memory controller according to (3), in which
the readout controlling section starts the reading out of the data for the cache line size in reference to an address for a first word in the bus request.
   (5)

The memory controller according to (3), in which
the readout controlling section starts the reading out of the data for the cache line size in reference to an address for a first word in the bus request and wraparound access information.
   (6)

The memory controller according to any one of (2) through (5), in which
the output controlling section outputs the multiple pieces of the data stored in the buffer, according to a bus protocol.
   (7)

The memory controller according to (6), in which
the output controlling section outputs the multiple pieces of the data stored in the buffer, one word by one word.
   (8)

The memory controller according to (1), in which
the burst access request is a request according to development of firmware at a time of system starting.
   (9)

The memory controller according to (1), in which
the burst access request is an access request for audio data.
   (10)

The memory controller according to any one of (1) through (9), in which
the memory includes a nonvolatile memory.
   (11)

The memory controller according to (10), in which
the nonvolatile memory includes a flash memory, an MRAM, a ReRAM, a FeRAM, or a phase change memory.
   (12)

A memory access method by a memory controller, including:
starting, in response to a burst access request for a memory, reading out of data from the memory without depending on completion of the burst access request;
storing multiple pieces of the data read out into a buffer; and
outputting the multiple pieces of the data stored in the buffer, according to a protocol of an outputting destination.

### REFERENCE SIGNS LIST

1L, 1R: Earphone
10: LSI
20: Memory
30: CPU
40: Cache memory
50: Bus
61: Processor
62: DMAC
100: Memory controller
111: SRAM
210: Bus I/F
220: Memory I/F
230: Buffer
240: Control section
241: Readout controlling section
242: Output controlling section

1. A memory controller comprising:
a readout controlling section that starts, in response to a burst access request for a memory, reading out of data from the memory without depending on completion of the burst access request;
a buffer that stores multiple pieces of the data read out; and
an output controlling section that outputs the multiple pieces of the data stored in the buffer, according to a protocol of an outputting destination.

2. The memory controller according to claim 1, wherein
the burst access request is a bus request according to a cache miss in a cache memory.

3. The memory controller according to claim 2, wherein
the readout controlling section starts the reading out of the data for a cache line size in response to the bus request.

4. The memory controller according to claim 3, wherein
the readout controlling section starts the reading out of the data for the cache line size in reference to an address for a first word in the bus request.

5. The memory controller according to claim 3, wherein
the readout controlling section starts the reading out of the data for the cache line size in reference to an address for a first word in the bus request and wraparound access information.

6. The memory controller according to claim 2, wherein
the output controlling section outputs the multiple pieces of the data stored in the buffer, according to a bus protocol.

7. The memory controller according to claim 6, wherein
the output controlling section outputs the multiple pieces of the data stored in the buffer, one word by one word.

8. The memory controller according to claim 1, wherein
the burst access request is a request according to development of firmware at a time of system starting.

9. The memory controller according to claim 1, wherein
the burst access request is an access request for audio data.

10. The memory controller according to claim 1, wherein
the memory includes a nonvolatile memory.

11. The memory controller according to claim 10, wherein
the nonvolatile memory includes a flash memory, an MRAM, a ReRAM, a FeRAM, or a phase change memory.

12. A memory access method by a memory controller, comprising:
starting, in response to a burst access request for a memory, reading out of data from the memory without depending on completion of the burst access request;
storing multiple pieces of the data read out into a buffer; and
outputting the multiple pieces of the data stored in the buffer, according to a protocol of an outputting destination.
